(19) United States
(12) Patent Application Publication
(10) Pub. No.: US 2013/0000824 A1
(43) Pub. Date: Jan. 3, 2013

(54) METHOD OF MANUFACTURING A TYRE OF SPLICED STRIPS

(76) Inventors: Marco Johan Put, Amersfoort (NL); John Van De Vrugt, Vaassen (NL); Cornelis Wouteres Janszen, Harderwijk (NL)

(21) Appl. No.: 13/576,524

(22) PCT Filed: Feb. 4, 2011
(86) PCT No.: PCT/NL2011/050080

§ 371 Date: Sep. 13, 2012

Related U.S. Application Data
(60) Provisional application No. 61/371,770, filed on Aug. 9, 2010.

(30) Foreign Application Priority Data
Feb. 9, 2010 (NL) 2004213

(51) Int. Cl. B29D 30/08

(52) U.S. Cl. 156/117

(57) ABSTRACT

Method for manufacturing a tyre from spliced strips, wherein the first strip is cut and the strip is placed on a discharge conveyor. After cutting the first strip a second strip is cut and placed on the discharge conveyor. After that the first and second strip are spliced. Between cutting the first strip and placing the second strip on the discharge conveyor the second strip is retained over the discharge conveyor, the projected separation distance between an end of the first strip and an end of the second strip to be spliced to said end is measured, and based on the measured separation distance the first strip is relatively displaced such with respect to the second strip that the end of the first strip is placed in the wanted position with respect to the second strip, after which the second strip is placed on the discharge conveyor.

### BACKGROUND OF THE INVENTION

The invention relates to a method for manufacturing a tyre of spliced strips of rubber material, particularly a band of unvulcanised rubber, more particularly cord-reinforced, wherein the method uses a cutting device for cutting strips from a band of material, wherein the cutting device is provided with a discharge device for discharging a cut strip, and with a splicer for splicing the cut strips, wherein the method comprises the steps of:
cutting a first strip from a band of rubber material, and placing the first strip on a discharge conveyor,
after cutting the first strip cutting a second strip from a band of rubber material, and placing the second strip on the discharge conveyor,
after the first and second strip have been placed on the discharge conveyor splicing the first and second strip for manufacturing a tyre of spliced strips.

Such a method is known from EP-A-2.125.304. In this case an end of a band of rubber material is engaged by a transfer device and taken over a cutting line of a cutting device onto a discharge conveyor and laid down thereon. The cutting device is activated for cutting the band of material so that a strip is formed. The length of the cut strip is measured and the strip is discharged by the discharge conveyor over the measured length of the strip. The cut strip is retained on the discharge conveyor by retaining means. Subsequently a next strip is cut in the same way, so that a trailing end of the first strip and a leading end of the next strip will abut each other. After that the strips are spliced. Although this method functions satisfactorily, in some cases inaccuracies may occur between the displacement of the band of material by the transfer device and the discharge conveyor, which inaccuracies in some cases might lead to the strips not being spliced in the desired manner.

### SUMMARY OF THE INVENTION

It is among others an object of the present invention to provide a method for manufacturing a tyre of spliced strips of rubber material, in which method use is made of a cutting device for cutting strips from a band of material, wherein the cutting device is provided with a discharge device for discharging a cut strip, and with a splicer for splicing cut strips, wherein such inaccuracies are avoided.

For that purpose a method of the type mentioned in the preamble according to the invention is characterised in that the method further comprises the steps of:
between cutting the first strip and placing the second strip on the discharge conveyor retaining the second strip over the discharge conveyor, measuring the projected separation distance between an end of the first strip and an end of the second strip to be spliced to said end of the first strip, based on the measured separation distance relatively displacing the first strip such with respect to the second strip that the end of the first strip is placed in the desired position with respect to the second strip, and after that placing the second strip on the discharge conveyor. Because after cutting the first strip the separation distance between a, particularly trailing, end of the first strip and a, particularly leading, end of the second strip to be spliced to said end of the first strip, is measured, it can be ensured that the ends are highly accurately placed against each other. In that way a highly accurate splice can be obtained.

### SHORT DESCRIPTION OF THE DRAWINGS

The invention will be elucidated on the basis of a number of exemplary embodiments shown in the attached drawings, in which:

FIGS. 1A-1G schematically show the various stages in the cutting and supplying of a band of material; and

FIGS. 2A-2I schematically show various stages in the supplying and cutting into strips of a band of material, and the splicing of cut strips.

### DETAILED DESCRIPTION OF THE DRAWINGS

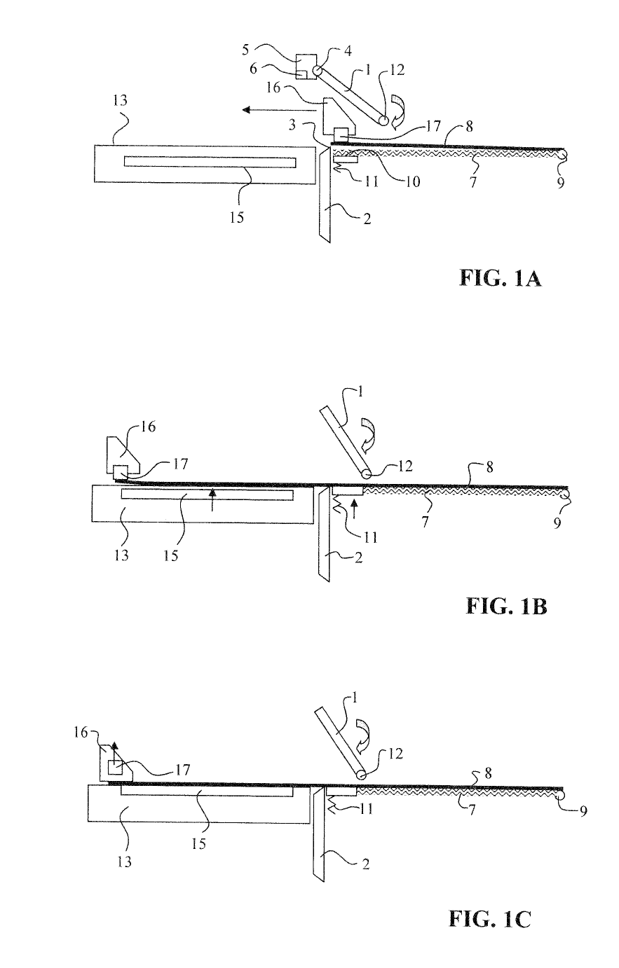

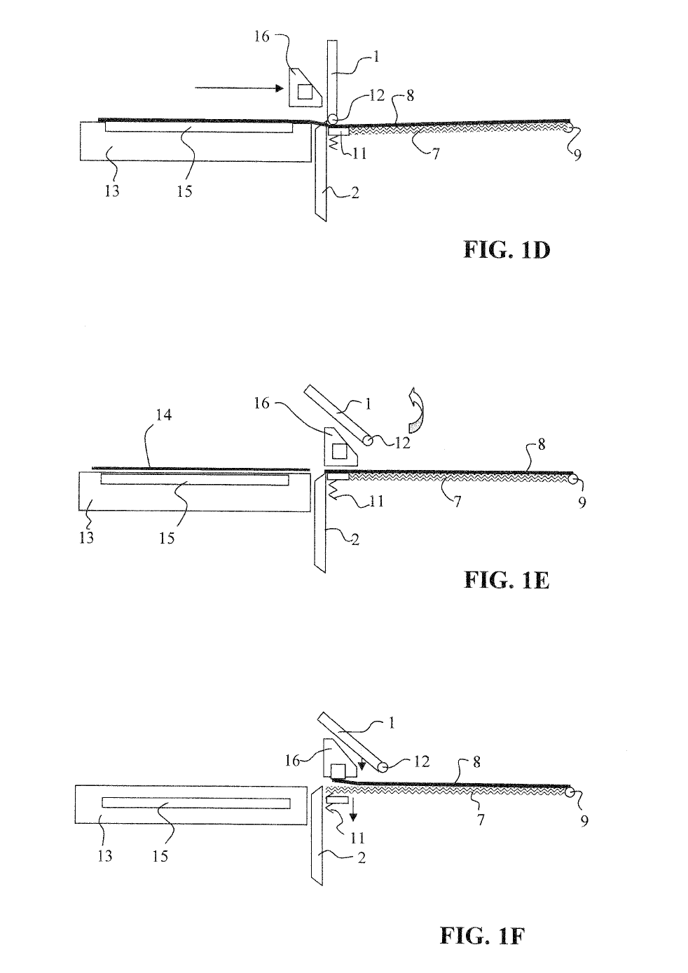

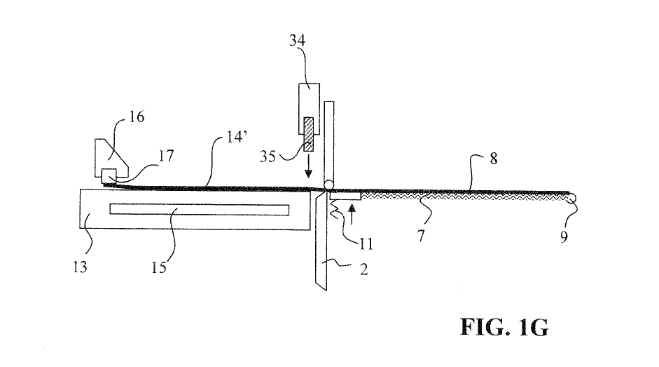

FIG. 1A schematically shows a view in cross-section of a cutting device for cutting strips from a band of material, particularly a band of unvulcanised rubber, more particularly cord-reinforced.

The cutting device is provided with an elongated upper blade 1 and a lower blade 2 movable along the elongated upper blade 1. The lower blade 2 is a rotatable, at least substantially circular blade, that has a bevelled cutting edge 3, which cutting edge 3 is oriented towards the upper blade 1.

The elongated upper blade 1 can be swung up to, at least substantially abutting contact with the lower blade 2, wherein the swinging comprises at least a component transverse to the elongated upper blade 1. In the embodiment shown in FIG. 1 the upper blade 1 can be swung about a swivel axis 4 that is parallel to the longitudinal direction of the upper blade 1.

The swinging of the upper blade 1 is effected by means of an electromotor, particularly a servomotor 5, and namely such that the upper blade 1 swings up to against the lower blade 2, as shown successively in FIGS. 1A-1D. When the upper blade 1 abuts the lower blade 2, the upper blade 1 exerts a force on the lower blade 2. After the upper blade 1 abuts the lower blade 2, the lower blade 2 is moved in the longitudinal direction along the upper blade 1 for cutting the material present between the upper blade and the lower blade. In that way a strip 14, 14′ (see FIGS. 1E and 1G) is cut off from the band of material 8.

In the embodiment shown the servomotor 5 is a controllable servomotor that is provided with a feedback device 6 for keeping the force with which the upper blade 1 presses against the lower blade 2 at least substantially constant. The feedback device 6 comprises a torque meter, particularly a current meter, for measuring and on the basis thereof controlling the force with which the servomotor 5 presses the upper blade against the lower blade. Although in the embodiment shown the feedback device is arranged in the servomotor said feedback device may also be housed elsewhere.

As shown in FIG. 1A the cutting device comprises a supply conveyor 7 for in the direction of the upper blade 1 and the lower blade 2 transporting a band of material 8. The supply conveyor 7 is bearing mounted so as to swing about a swivel axis 9, and at its discharge end 10 is provided with a pre-stressing device 11. Said pre-stressing device 11 pushes the discharge end 10 of the supply conveyor 7 in the direction of the upper blade 1. In that way it is ensured that when swinging the upper blade 1 up into contact with the discharge end 10, the band of material is clamped in a defined manner between the upper blade 1 and the upper surface of the supply conveyor 7, as a result of which a proper cut of the band of material 8 can be achieved. The upper blade 1 is provided with a roller element 12 in order to ensure that the upper blade 1 when moving over the band of material 8 does not cause any unwanted tensions and/or deformations in it and the band of material 8 is pressed onto the supply conveyor 7.

The pre-stressing device 11 comprises an elastic element, which in the embodiment shown is a spring.

As shown in FIG. 1A everything is positioned such that the discharge end 10 of the supply conveyor 7 is adjacent to the lower blade 2. In that case, when the upper blade 1 has been swung up into contact with the upper surface of the discharge end 10 of the supply conveyor 7, the cutting surface of the upper blade 1 is adjacent to the cutting surface of the lower blade 2.

As shown in FIG. 1A the cutting device comprises a discharge conveyor 13 for discharging a cut strip 14, 14′ from the upper blade 1 and lower blade 2. In the embodiment shown in FIGS. 1A-1F the upper surface of the discharge conveyor 13 and the upper edge (the tip of the cutting edge 3) of the lower blade 2 are in one plane. In that way the cut off strip after cutting remains at the same level as the band of material is situated prior to cutting, which is advantageous for the shape of the cut off strip. In other words, as the strip does not drop onto the discharge conveyor, undesired changes in shape do not arise.

In the embodiment shown in FIGS. 1A-1F the discharge conveyor 13 is provided with a movable transport surface for discharging the strip, and below the transport surface a retaining magnet 15 is arranged for retaining the strip 14, 14′ on the transport surface. Said retaining magnet 15 is arranged so as to be movable in height with respect to the transport surface.

As among others shown in FIG. 1A the cutting device is provided with a transfer unit having a movable transfer device 16 for engaging the band of material 8 on the supply conveyor 7 and for transferring the band of material 8 to beyond the upper blade 1 and lower blade 2 up onto the discharge conveyor 13. In the embodiment shown the transfer device 16 is provided with a magnet beam 17 for engaging the free outer end of the band of material 8. In this case the engaging/retaining and the releasing again of the band of material (cord-reinforced) is facilitated because the magnet beam 17 is mounted so as to be movable in a holding structure as schematically indicated in FIG. 1C by the arrow.

In a manner known per se the cutting device is provided with a control unit (not shown in the figures), such as for instance a computer or microprocessor, for controlling the mutual motions and operation of the various parts of the cutting device.

Said control unit ensures among others the synchronisation of the swinging of the upper blade 1 and the movement of the transfer device 16, 17.

The operation of the cutting device will be elucidated in short on the basis of FIG. 1.

In FIG. 1A the situation is shown in which the supply conveyor 7 has moved a band of material 8 up to the discharge end 10 of the supply conveyor 7. The upper blade 1 has been swung upwards, and magnet beam of the transfer device 16 has been brought into contact with the outer end of the band of material 8 in order to engage it. The transfer device 16 subsequently moves to the left (as indicated by the arrow) and simultaneously the upper blade 1 is swung downwards. When the transfer device 16 has reached the desired position on the discharge conveyor 13 (FIG. 1B), the transfer device 16 places the band of material on the upper surface of the discharge conveyor 13. The retaining magnet 15 is moved upwards, so that the retaining magnet 15 fixates the band of material 8 in position with respect to the discharge conveyor 13. Subsequently the magnet beam 17 is moved upwards within the supporting structure of the transfer device 16 (as shown in FIG. 1C), so that the transfer device 16 releases the band of material 8.

The upper blade 1 has meanwhile pressed the band of material 8 against he supply conveyor 7 (FIG. 1D), wherein the discharge end 10 of the supply conveyor 7 is pressed down slightly counter the action of the pre-stressing device 11. The transfer device 16 is moved into a waiting position before the upper blade 1, and then during cutting assumes a holding position: during cutting the material is retained (extra) on the discharge conveyor in the vicinity of the cutting line.

During making the incision the servomotor 5 with the feedback device 6 ensures that the force with which the upper blade 1 presses against the lower blade remains constant, so that the incision is highly accurate. Due to the retaining magnet 15 the cut off strip remains sitting defined on the discharge conveyor.

Subsequently the upper blade 1 is swung upwards, and the transfer device 16 is moved to above the supply conveyor 7 (FIG. 1E), the strip is discharged by the discharge conveyor 13, and the retaining magnet 15 moves to some distance below the upper surface of the discharge conveyor 13 (FIG. 1F), after which the next strip can be cut.

Subsequently a next strip 14′ is cut (FIG. 1G), which takes place differently from the cutting of the previous strip 14. The material for the next strip 14′ is picked up by the retaining device 16 and transported to beyond the cutting line in the direction of the discharge conveyor 13. Contrary to the previous strip 14 the material for the next strip 14′ is not retained on the discharge conveyor 13 by means of the retaining magnet 15, but retained above the discharge conveyor 13 by the retaining device 16 on the one hand and the upper blade 1 (see FIG. 1G). Considered in perpendicular projection on the discharge conveyor 13 the trailing end of the previous strip 14 is at a distance G from the leading end of the material for the next strip 14′. Said distance is measured by a measuring device. The measuring device comprises an optical sensor 34, in particular a camera, which is able to detect both the trailing end of the first strip 14, and the leading end of the second strip 14′. Detection takes place near the cutting line, particularly at a short distance adjacent to the longitudinal side edge of the strips 14, 14′ facing the lower blade 2. The distance is in the order of a few centimetres, preferably below 10 centimetres, more preferably below 5 centimetres. This area will be exposed to light by means of a light source 35, particularly a laser, wherein the line source 35 provides a linear exposure to light that is substantially parallel to the longitudinal direction of the tyre to be manufactured by means of the strips 14, 14′ and/or to the discharge conveyor 13.

The linear exposure to light is placed substantially parallel to and adjacent to a cutting line of the cutting device that is formed by the upper blade 1 and lower blade 2, wherein the linear exposure to light extends over a portion of the first strip 14 near its end that faces the second strip 14′, over a portion of the second strip 14′ near its end that faces the first strip 14, and over an area with length G between the first 14 and second strip 14′. The sensor 34 detects the area exposed to light and is able to determine the length of the linear exposure to light between the strips 14, 14′ and therefore the distance G between the first strip 14 and the second strip 14′.

Subsequently the discharge conveyor 13 is driven backwards as a result of which the trailing end of the first strip 14 retained on the discharge conveyor 13, is placed near the leading end of the second strip 14′ retained above the discharge conveyor 13, such that further down the process the trailing end of the first strip 14 can be connected to the leading end of the second strip 14′ by means of a splice.

Subsequently the retaining magnet 15 is moved upwards, so that the retaining magnet 15 fixates the second strip 14′ in position with respect to the discharge conveyor 13 and the second strip 14′ can be cut off from the band of material 8 as shown in FIG. 1D.

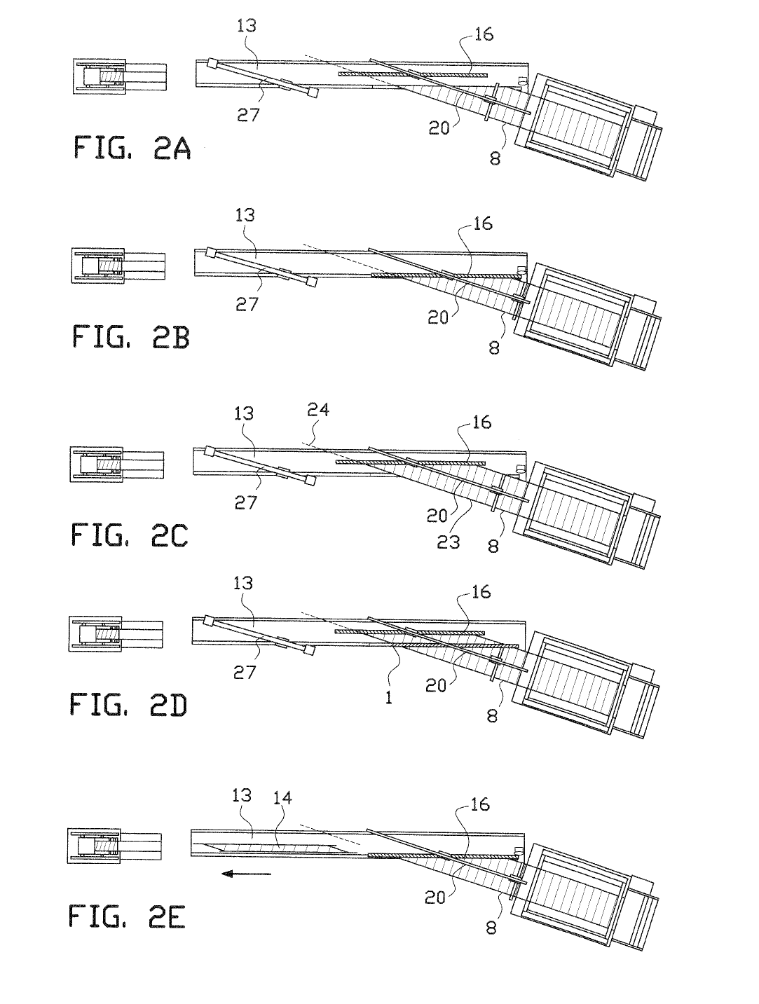

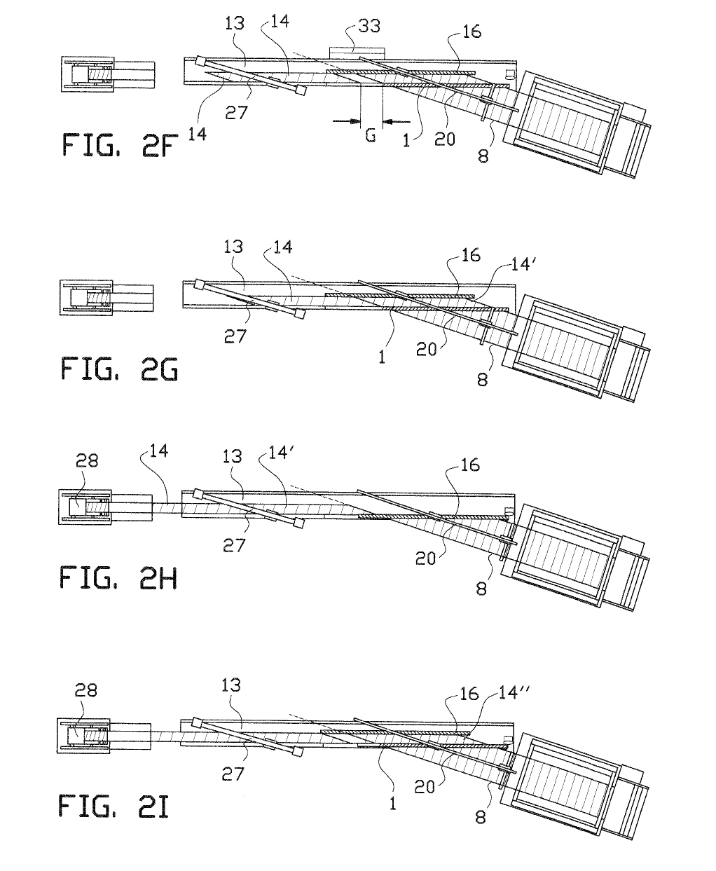

On the basis of FIGS. 2A-2I the inventive method for manufacturing a tyre from spliced strips of rubber material will be elucidated in short.

In FIG. 2A the starting position is schematically shown in top view. In FIG. 2B the transfer device 16 has been moved to above the outer end of the band of material 8 for engaging/retaining the band of material. In FIG. 2C the transfer device 16 has taken the band of material 8 over the cutting line towards the discharge conveyor 13 and laid it down thereon so that an edge 23 of the band of material 8 ends up on the line 24. In FIG. 2D the situation is shown in which the upper blade 1 has been moved to a position adjacent to the cutting line and retains the band of material there, after which the lower blade moves along the upper blade for cutting the band of material 8, so that the strip 14 is formed. After that the cut strip 14 is discharged by the discharge conveyor 13 over a displacement distance that exceeds the length of the strip 14 in discharge direction (indicated by the arrow). The strip 14 has now arrived in the position shown in FIG. 2E. The strip is retained in this position. For the sake of clarity of the drawing the splicer 27 is not shown in FIG. 2E.

Subsequently a next strip 14′ is cut (FIGS. 2F, 2G), which takes place differently from the cutting of the previous strip 14. The material for the next strip 14′ is picked up by the retaining device 16 and transported to beyond the cutting line in the direction of the discharge conveyor 13. Contrary to the previous strip 14 the material for the next strip 14′ is laid down loosely on the discharge conveyor 13 and retained over the discharge conveyor 13 by the retaining device 16 and the upper blade 1. Considered in perpendicular projection on the discharge conveyor 13 the trailing end of the previous strip 14 is at a distance G from the leading end of the material for the next strip 14′ (FIG. 2F). Said distance is measured by a measuring device 33.

The measuring device 33 detects the intermediate space between the previous strip 14 and the next strip 14′. Instead of the measuring device 33 use can also be made of the measuring device 34, 35 as described and shown above in FIG. 1G.

After that the discharge conveyor 13 is activated so that the previous strip 14 is moved back over the measured distance G, so that the trailing end of the previous strip 14 is situated exactly below the leading end of the material for the next strip 14′ (or at another position desired for the splice to be made).

Instead of measuring the distance G and moving back the discharge conveyor 13 over said distance G, in an alternative embodiment the distance during the returning movement of the discharge conveyor 13 is constantly checked, wherein the movement of the discharge conveyor 13 can be controlled based on the constant measurements until the distance between the previous strip 14 and the next strip 14′ is substantially zero.

After that the retaining device 16 can release the material for the next strip 14′ and the material for the next strip 14′ is placed on the discharge conveyor (FIG. 2G). A retaining magnet 15 placed under the discharge conveyor 13 ensures that the strips and 14′ are retained in their correct position on the discharge conveyor. Subsequently the next strip 14′ can be cut off from the material 8 by means of the lower blade 2 and the upper blade 1. After that the combination of previous and next strip 14, 14′ is moved by the discharge conveyor up to a position below the splicer 27 (FIG. 2H), after which the strips 14, 14′ are connected by means of a splice.

Simultaneously to splicing a further strip 14″ can be cut in the same way as the next strip 14′, as shown in FIG. 21.

In this way a long succession of spliced strips can be formed which for instance can be wound onto a supply roll 28 or which can directly be discharged for further processing in a tyre, such as a car tyre or airplane tyre.

Although the invention is described on the basis of the cutting device as shown in EP-A-2.125.304, it will be evident to the expert that the method according to the invention can also be used in other cutting devices, such as the one that is for instance described in EP-A-1.824.648.

1. Method for manufacturing a tyre from spliced strips of rubber material, wherein the method makes use of a cutting device for cutting strips from a band of material, wherein the cutting device is provided with a discharge device for discharging a cut strip, and with a splicer for splicing cut strips, wherein the method comprises the steps of:
cutting a first strip from a band of rubber material, and placing the first strip on a discharge conveyor,
after cutting the first strip cutting a second strip from a band of rubber material, and placing the second strip on the discharge conveyor,
after the first and second strip have been placed on the discharge conveyor splicing the first and second strip for manufacturing a tyre of spliced strips,
characterised in that the method further comprises the steps of:
between cutting the first strip and placing the second strip on the discharge conveyor retaining the second strip over the discharge conveyor, measuring the projected separation distance between an end of the first strip and an end of the second strip to be spliced to said end of the first strip, based on the measured separation distance relatively displacing the first strip such with respect to the second strip that the end of the first strip is placed in the desired position with respect to the second strip, and after that placing the second strip on the discharge conveyor.
